(19) United States
(12) Patent Application Publication
(10) Pub. No.: US 2008/0165701 A1
(43) Pub. Date: Jul. 10, 2008

(54) COLLABORATIVE DOWNLOADING FOR MULTI-HOMED WIRELESS DEVICES

(75) Inventors: Ganesh Ananthanarayanan, Chennai (IN); Venkata N. Padmanabhan, Bangalore (IN); Chandramohan A. Thekkath, Palo Alto, CA (US); Lenin Ravindranath Sivalingam, Chennai (IN)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/765,873

(22) Filed: Jun. 20, 2007

(30) Foreign Application Priority Data
Jan. 4, 2007 (IN) 35/DEL/2007

(51) Int. Cl. H04L 12/28

(52) U.S. Cl. 370/254

(57) ABSTRACT

A system is disclosed for collaborative downloading that uses both the WLAN and the WWAN in combination, in an attempt to bridge the range-speed dichotomy. Devices in close vicinity band together their WWAN links, with the high-speed WLAN serving as the glue, to boost the effective wide-area bandwidth available to the active nodes.

### CROSS-REFERENCE TO RELATED APPLICATION

The present invention is related to U.S. patent application Ser. No. 11/555,084, entitled “Collaborative Networks for Parallel Downloads of Content,” which application is incorporated by reference in its entirety herein.

The present application claims priority to Indian Patent Application Serial No. 35/DEL/2007, entitled “Collaborative Downloading For Multi-Homed Wireless Devices,” by G. Ananthanarayanan et al., filed in India on Jan. 4, 2007, which application is incorporated by reference herein in its entirety.

### BACKGROUND

Mobile devices such as laptops, smartphones, and PDAs are increasingly being equipped with multiple wireless network interfaces. These include one or more wireless LAN interfaces (e.g., 802.11, Bluetooth) and wireless WAN interfaces (e.g., GPRS, UMTS). This allows devices to have a choice of radios to use separately. Since the WLAN offers much higher speeds than the WWAN (a few to tens of Mbps as compared to tens to hundreds of Kbps), the conventional wisdom is to use the WLAN interface when in range of a WLAN (e.g., at a WiFi hotspot), but settle for the much lower speeds offered by the WWAN interface at other times.

Despite the proliferation of WiFi hotspots, their coverage is still quite limited (e.g., no coverage outside the city center or on trains and buses). Furthermore, even in locations with WiFi coverage, policy issues may impede a user's ability to take advantage of it (e.g., the user may not be a subscriber of the hotspot service provider and so may have to set up yet another billing relationship). Such a mismatch is less likely to arise on the large footprint WWAN because the user's own provider is often within reach.

Considerable research has gone into improving download performance. One stream of research focuses on throughput enhancement by a more efficient and aggressive use of a single network interface. Download performance can be accelerated by opening multiple connections from the client to various replicas or mirrors of websites. See for example, A. Miu and E. Shih. Performance analysis of a dynamic parallel downloading scheme from mirror sites throughout the internet. Technical report, MIT LCS, December 1999, and P. Rodriguez, A. Kripal, and E. W Biersack. Parallel-access for mirror sites in the internet. In IEEE Infocom 2000, March 2000.

The evolution of devices with multiple network interfaces has opened up a whole new area of research where researchers tried to overcome the limitations in the bandwidths of a single WWAN interface using bandwidth aggregation. The work broadly follows two paths: one where the bandwidths of all the WWAN links attached to a single device are aggregated and the second where multiple devices collaborate to aggregate their individual bandwidths.

Mechanisms are known for inverse multiplexing (i.e., striping packets) across multiple WWAN links to avoid problems such as TCP packet reordering. See for example A. Qureshi and J. Guttag. Horde: Separating Network Striping Policy from Mechanism. In ACM/Usenix MobiSys, June 2005, H.-Y. Hsieh and R. Sivakumar. A transport layer approach for achieving aggregate bandwidth on multi-homed mobile hosts. In ACM International Conference on Mobile Computing and Networking (MOBICOM), pages 83-94, September 2002, and A. C. Snoeren. Adaptive Inverse Multiplexing for Wide-Area Wireless Networks. In IEEE Global Internet Symposium, December 1999. Since these systems assume that the multiple WWAN links are attached to the same device, the issues of how to accomplish local communication and provide incentives for cooperation are not considered. P Rodriguez, R. Chakravorty, J. Chesterfield, I. Pratt, and S. Banerjee, MAR: A Commuter Router Infrastructure for the Mobile Internet, In ACM/Usenix MobiSys, June 2004, disclose a system making use of the multiplicity of the wireless networks available by dynamically instantiating new channels based on traffic demand, aggregating the bandwidth and dynamically shifting load from poor quality to better quality channels.

Other systems have considered coordinating communications from multiple mobile computing devices. It is known to provide a network-layer inverse multiplexer (PRISM-IMUX) at the proxy and a congestion-control mechanism (TCP-PRISM) at the sender side. See, for example, K.-H. Kim and K. G. Shin. Improving TCP Performance over Wireless Networks with Collaborative Multi-homed Mobile Hosts. In MobiSYS '05: Proceedings of the 3rd international conference on Mobile systems, applications, and services, pages 107-120. ACM Press, June 2005.

Further systems propose an application-aware and channel-adaptive architecture for flow assignment over multiple links. See, for example, P. Sharma, S.-J. Lee, J. Brassil, and K. G. Shin. Handheld Routers: Intelligent Bandwidth Aggregation for Mobile Collaborative Communities. In BROADNETS '04: Proceedings of the First International Conference on Broadband Networks, pages 537-547. IEEE, October 2004. It is also known to provide a system having group mobility where a user's set of devices collaborate to appear as a single entity in the Internet. C. Carter and R. Kravets. User Devices Cooperating to Support Resource Aggregation. In Proceedings of the Fourth IEEE Work shop on Mobile Computing Systems and Applications (WMCSA '02), pages 59-69. IEEE, June 2002.

A shortcoming of all of these systems is that they have side-stepped the issue of incentives and accounting, and simplified the problem of local communication by either assuming that the same device owns all the devices, the presence of a separate aggregation router, or that the improved performance alone is sufficient incentive for cooperation. The mere promise of improved performance may not be a sufficient incentive for cooperation because of the ephemeral association between mobile nodes. While H. Luo, R. Ramjee, P Sinha, L. Li, and S. Lu. UCAN: A Unified Cellular and Ad-hoc Network Architecture, In ACM International Conference on Mobile Computing and Networking (MOBICOM), September 2003, considers secure crediting, it uses the WLAN to increase the reach of the WWAN rather than for bandwidth aggregation, and more importantly, it ignores a key resource, viz. energy.

The notion of providing incentives to nodes in an ad hoc network for a collaborative activity has been presented in the context of forwarding in ad hoc networks. Forwarding in ad hoc networks, however, is different from the collaboration of the present system. In ad hoc networks, nodes rely on each other to communicate amongst themselves. In a mobile community, nodes rely on each other not for basic connectivity but for performance improvements.

Peer selection in a free market scenario has been done for optimizing speed in the context of streaming video. See, for example, M. Adler, R. Kumar, K. Ross, D. Rubenstein, D. Turner, and D. Yao”. Optimal peer selection in a free market peer-resource economy. In Second Workshop on Economics of Peer-to-Peer Systems, June 2004, and R. Gupta and A. K. Somani. Compup2p: An architecture for sharing of computing resources in peer-to-peer networks with selfish nodes. In Second workshop on the Economics of Peer-to-Peer systems, June 2004. However, this work does not optimize throughput in the context of collaborative communities for downloading data.

### SUMMARY

The present technology, roughly described, relates to a system for collaborative downloading that uses both the WLAN and the WWAN in combination, in an attempt to bridge the range-speed dichotomy. In embodiments, devices in close vicinity band together their WWAN links, with the high-speed WLAN serving as the glue, to boost the effective wide-area bandwidth available to the active nodes.

In embodiments, nodes in close vicinity use the high-speed WLAN to discover each other, form a collaboration group, and stripe traffic across their WWAN links, increasing the effective WAN download speed available to any one node. All of these steps happen automatically, with user involvement limited to setting policy. Pooling together WWAN links among a set of collaborating but uncoordinated nodes raises several challenges, which are addressed in the present system by the following features:

1) Incentives for cooperation: By contributing its WWAN bandwidth for the benefit of its peers, a device typically incurs both a monetary cost (e.g., WWAN charges) and an energy cost. It is important that these costs be accounted for as peers provide/seek help to/from each other. A framework of incentives has been developed for collaboration that addresses several practical issues including the unification of monetary and energy costs, and on-the-fly estimation of the energy cost of communication in a system in operation.

2) Cost modeling: By contributing its WWAN bandwidth for the benefit of its peers, a node typically incurs both a monetary cost (e.g., WWAN charges) and an energy cost. It is important that these costs be accounted for as peers provide/seek help to/from each other. The present system includes techniques for inferring the energy cost on-the-fly and unifying it with the monetary cost.

3) Accounting: The costs computed above form the basis of a market wherein nodes buy and sell WWAN bandwidth resources. The present system includes a lightweight and secure accounting scheme to keep track of the credits earned or debits incurred as nodes buy and sell bandwidth.

4) Collaboration group formation: Assuming two or more nodes wish to collaborate, the present system includes an energy-efficient protocol for them to rendezvous with each other, exchange their bids, and form a collaboration group. The present protocol for group formation is novel in that it is both energy efficient and adaptive to fluctuations in network conditions.

5) Lack of Special-purpose Proxies: An effective application-level striping procedure has been developed that avoids the need for special-purpose proxies in the infrastructure. Much of the earlier work proposes the use of such proxies, which makes it impractical to implement those solutions. Once a collaboration group has been formed, the present system uses an adaptive workload distribution algorithm to farm out work across the participants in the collaboration group. Also, the present system uses HTTP byte-range requests to affect the striping, which trades off generality for improved deployability compared to prior work that has focused on striping at the network layer and consequently required special-purpose proxies in the infrastructure.

6) Security: It is important to ensure that in sharing their WWAN bandwidth, the participating devices do not compromise their security. The present system addresses privacy, confidentiality, as well as authenticity.

7) User Interface: An effective user interface enabling users to control the operation of the present system.

Although the present system is based on HTTP-level striping, there are many aspects of the system (e.g., cost modeling and workload distribution) that could be applied in a setting where striping is done at the network layer instead.

In embodiments described above, an initiator is the focal point for the process, in that they request, sort through and accept bids from collaborators in accordance with the present system. In an alternative embodiment, for example where the initiator wishes to minimize power expenditure, the initiator may offload the process to a third party, at which point the initiator may turn off their radio. The third party then undertakes the process of request, sorting and acceptance of bids from collaborators, as well as any other tasks otherwise performed by the initiator. In such an embodiment, the initiator may set an appointed time with the third party to wake-up, at which point the initiator may receive the downloaded content from the third party.

### BRIEF DESCRIPTION OF THE DRAWINGS

FIG. 1 is a graph of the power depleted over time by an i-mate PocketPC with Bluetooth and 802.11 networks in varying power states.

FIG. 2 is a graph plotting the reduction in throughput due to the initial connection establishment for HTTP downloads.

FIG. 3 is a graph of the increase in measured HTTP throughput with an increase in collaboration group size.

FIG. 4 is a graph plotting the throughput of the present system as the ratio T̅C̅_{G}/ T̅C̅ increases in a five-node scenario.

FIG. 5 is a graph showing the effect of progressively slowing a single collaborator from 0.75 to 0.1 of its original rate.

FIG. 6 is a graph illustrating the efficacy of the prioritization module.

FIG. 7 is a user interface for operating the present system.

FIG. 8 is a block diagram of a computing system environment on which the present system may be implemented.

FIG. 9 is a block diagram of a hand-held computing system environment on which the present system may be implemented.

### DETAILED DESCRIPTION

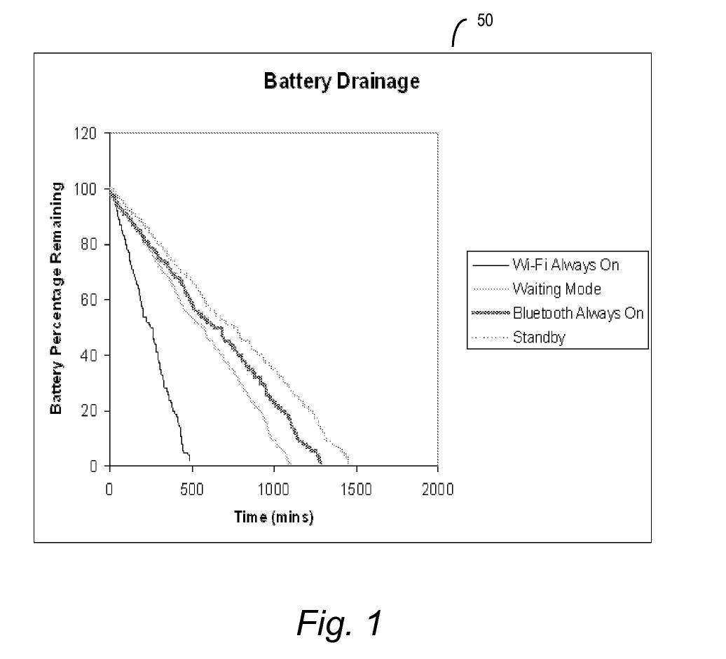

The present system will now be described with reference to FIGS. 1-9, which in general relate to a system for collaborative downloading that uses both the WLAN and the WWAN in combination. The present system enables a mobile device to utilize the WWAN links of devices in its vicinity to boost the effective WWAN speed available to it. The motivating application is large downloads, which would likely benefit the most from a bandwidth boost. Given the growing market for mobile music and video download, the speedup provided by collaborative downloading would significantly enhance user experience. WWAN providers would encourage such sharing among users on their networks, as it would help improve user experience through software means, without the need for expensive hardware upgrades.

A requester (also referred to herein as an initiator) seeks to utilize the WWAN links of one or more collaborators. A collaborator may contribute its WWAN bandwidth when it is not in local use. As the collaborator would incur a cost in contributing its unused WWAN bandwidth, there is the need for incentives to offset this cost. The cost comprises both the monetary tariff imposed by the WWAN provider and the opportunity cost of expending battery energy (i.e., expending energy on behalf of a peer might diminish the ability of a user to use the device for their own purpose).

In the present system, each collaborator estimates its cost of providing help and communicates it as its price to the initiator. (In general, the collaborator could, based on user policy, scale up or down its price relative to its cost to reflect how aggressive it wants to be as a seller.) In turn, the initiator compares the bids offered by multiple collaborators, picks the ones that are low enough, and proceeds to form a collaboration group.

Given device mobility and the consequent ephemeral nature of association between devices, a collaborator cannot count on the initiator being in its vicinity at a later time when the collaborator needs help. To address this issue, the present system includes an accounting mechanism, wherein the initiator issues signed IOUs to its collaborators, who then redeem these by contacting an accounting server at some later point in time.

In the process of exchanging bids and forming a collaboration group, a key challenge is in enabling the initiator to rendezvous with potential collaborators in its vicinity in an energy-efficient manner. Since this process happens occasionally and at unpredictable times, it unacceptable to have the potential collaborators be constantly listening for initiator requests. Instead, the present system uses a combination of a low-power radio (e.g., Bluetooth) and periodic wakeups to achieve energy efficiency, while trading off a little in group formation speed.

Once a collaboration group has been formed, the initiator uses an adaptive work-queue algorithm to distribute work across the collaborators. This algorithm adapts to dynamic variations in WWAN link speed across the collaborators and also to local traffic at the collaborators, which takes priority over the present system traffic.

Embodiments of the present system use HTTP byte-range requests to stripe traffic across multiple WWAN links. While this HTTP level mechanism is not as general as prior link- or network-level striping schemes, it avoids the need for a special-purpose proxy in the infrastructure to split and splice flows. This provides a significant advantage from a deployment viewpoint.

Cost Modeling

It is desirable that the cost of sharing bandwidth be modeled appropriately, so that the offered price is high enough to adequately compensate the collaborator but not so high as to be unattractive to the initiator. There are two principal costs that a collaborator incurs in helping the initiator. The first is the cost of transferring data on the WWAN link for which the WWAN service provider extracts a fee. This fee depends on the tariff structure imposed by the service provider and may depend, in general, on factors such as the user's service plan and the time of day. Nonetheless, given a tariff structure, one can estimate the cost of WWAN usage for transferring a given amount of data, although some projection of anticipated future usage may be needed (say, based on past usage patterns) to account for tiered pricing. Also, if flat rate pricing is being used, there may not be an incremental cost to additional data transfer. Nevertheless, a user would want to amortize their monthly dues over the expected (or typical) monthly usage. For the present purposes, it is assumed that the WWAN tariff is known and is a uniform rate per unit data.

The second cost is the opportunity cost of expending battery energy on behalf of a peer. Battery energy is a meager resource for mobile devices, so by expending it in this manner, a collaborator increases the risk of running out of battery energy for its own use. The present system provides a framework for quantifying energy cost and unifying it with monetary cost.

Quantifying energy cost and unifying it with monetary cost presents a challenge. While both energy and money are valuable resources, they are quantified in different units that need to be reconciled. Furthermore, the opportunity cost of expending energy would depend not just on the amount of energy expended but also the likelihood that the expenditure would deprive the user the use of their device. For example, if the battery is likely to be recharged before it fully drains, the user would not really incur an opportunity cost. Finally, the opportunity cost would be a function of the utility of a mobile device for its user. It would be lower for a user who is idling compared to a user who needs to have use of their device at any cost.

In the present system, the opportunity cost is modeled as a function of the fraction of battery energy remaining (BR), which falls in the range [0,1]. The smaller BR is, the more precarious the device's energy state is, and so the more valuable battery energy is likely to be to the user. 1/BR may be used as the opportunity cost, which is consistent with the inverse relationship between BR and the opportunity cost.

In order to unify the opportunity cost of expending energy with the monetary cost (MC) of performing a data transfer, MC may be scaled by the opportunity cost 1/BR. Hence the total cost is TC=MC/BR. Since BR is dimensionless, TC is also expressed in monetary units, which is convenient from the viewpoint of accounting.

In the common case, a collaborator performs a WWAN transfer on behalf of the initiator. So the monetary cost, MC, is a function of the tariff rate and the WWAN transfer size (e.g., simply a product of the two if the tariff rate per byte is uniform). However, it is possible that the collaborator has an up-to-date copy of the requested file in its cache, in which case a WWAN transfer is not needed. Nevertheless, since the collaborator had presumably incurred the cost of a WWAN transfer at some point in the past, MC may be computed to be what the WWAN tariff would be for a transfer of the corresponding size. In embodiments, this cost may be amortized over multiple requests for the same cached file.

Variations in the utility of a mobile device for its user may be accommodated by scaling up or down TC based on user input. As explained hereinafter, the scaling factor, Ks, is set to 1 by default. A user who is very keen not to deplete their battery would set Ks to a large value whereas another user without a pressing need for their device (or who expects to be recharging it in the near future) may choose to set Ks to a low value, in an attempt to make their bids attractive and earn credits for future use.

The procedure discussed above for computing the total cost, TC, depends on the current level of battery remaining, BR, which can be queried directly from the OS. However, computing TC is this manner would only be appropriate for data transfers that are small enough that BR does not change significantly on account of the data transfer itself. While the data transfer chunk size used in the workload distribution scheme discussed above satisfies this requirement, it is still desirable to be able to estimate the energy usage (in terms of battery depletion) for longer transfers. This would allow estimating how much more expensive a collaborator's bid is likely to become in the future, allowing the initiator to make a more informed choice when it is seeking collaborators for a sustained period and wants to minimize churn in its collaboration group.

Accordingly, during group formation, the initiator seeks not only the current bid from a collaborator but also information on how the bid is likely to change for every additional (large) unit of data transferred through the collaborator (for example, every MB of data). Knowing the size of the file to be downloaded (determined, for example, using an HTTP HEAD request), the initiator can then evaluate the suitability for each collaborator for sustained participation.

There has been much work on measuring and characterizing the energy consumption of network activity in mobile devices. However, the focus has been on measuring this in controlled settings, possibly using special instruments to measure the current drawn by the NIC. While this may be accurate, it is not suitable for use in devices in the field, especially as their characteristics (e.g., the capacity of the battery to hold charge) change over time.

In contrast, the present system seeks to estimate the energy consumption of network activity based on observations of the device in operation. A simple linear model for the battery depletion is used:

BD=time_elapsed*BDₜ+bytes_sent_or_recd*BD_{d}.

BD is the total battery depletion, expressed as a fraction of the full battery capacity. BDₜ is the battery depletion per unit time and it reflects the cost of keeping the device, including the NIC, turned on. BD_{d} is the battery depletion per unit data sent or received (clubbing both together simplifies the model and is also supported by measurement data showing that the costs of wireless transmission and reception are similar).

While the device is in operation, the volume of network activity (i.e., the count of bytes sent or received on a NIC, as reported by netstat) may be sampled and the battery remaining at various times. Using these samples, multivariate linear regression may be applied to estimate BDₜ and BD_{d}.

Since the energy characteristics of the WLAN and the WWAN NICs are likely to be different, the battery depletion rate needs to be estimated separately for each. However, to avoid complicating the model too much, sampling may be focused on periods of the present system activity, when both NICs are turned on (because only estimating energy usage during such periods is relevant.) Separate variables, BD_{d}_{_{—}}_{WLAN} and BD_{d}_{_{—}}_{WWAN} may be introduced to represent the battery depletion per unit data. However, a single BDₜ may be retained that reflects the battery depletion per unit time on account of keeping the devices, including both NICs, turned on. The model therefore becomes:

BD=time_elapsed*BDₜ+bytes_sent_or_recd_{WLAN}*BD_{d}_{_{—}}_{WLAN}+bytes_.sent_or_recd_{WWAN}*BD_{d}_{_{—}}_{WWAN}.

Accounting

For an incentive scheme based on the cost model described above to work, an accounting mechanism is needed to keep track of payments made by initiators to the collaborators they recruit. There are several properties that a practical accounting scheme may have:

1) Storing credits: Given the mobility of nodes and the ephemeral association between them, a collaborator who provides help cannot count on the initiator being available to return the favor at a different time and place. So the accounting mechanism may store credits for future use; a real-time tit-for-tat scheme as in BitTorrent would not suffice.

2) Cheat-Proof: The accounting scheme may be able to limit the damage caused by an initiator who fails to provide the promised compensation to a collaborator (e.g., by using counterfeit money for payment) or a collaborator who fails to provide the promised help.

3) Privacy: The accounting scheme may not leak information on the identities of the collaborator and the initiator to each other, or to a third party.

4) Flexibility: The accounting scheme may be flexible enough to accommodate real money as well as artificial forms of currency.

5) Efficiency: The computational and communication overhead of accounting may be low, possibly insignificant compared to the cost of the primary task at hand, i.e., data transfer. This may be important given the resource limitations of mobile devices.

In embodiments, it is possible to use an existing digital payment system to enable an initiator and its collaborators to exchange payments. Electronic funds transfer (EFT), which is widely supported by banks, is one possibility. However, EFT may be cumbersome in practice (e.g., the collaborator would have to share its bank account information with the initiator). It also imposes overhead on the collaborator (especially when fine-grained payments are made) in confirming the EFT with its bank online, to prevent cheating by the initiator.

An alternative would be to use digital cash, possibly adapted for efficient micropayments. Such a system is disclosed for example by S. Glassman, M. Manasse, M. Abadi, P. Gauthier, and P. Sobalvarro. The Millicent Protocol for Inexpensive Electronic Commerce. In The World Wide Web Journal, Fourth International World Wide Web Conference Proceedings, December 1995, which reference is incorporated by reference herein in its entirety. An advantage of such systems is their privacy, which is equivalent to that of paper cash. However, double spending is a risk, preventing which requires either the overhead of online communication with the bank that issued the cash or the provision of a secure hardware device (e.g., smartcard) at the clients to detect or prevent duplication.

In embodiments of the present system, a credit-based scheme may be employed that offers protection against double spending without requiring (expensive) online communication with a server in the infrastructure. The scheme leverages a central authority to issue public/private key pairs, and the corresponding certificates, to each user upon presentation of a proof of identity (e.g., a credit card). This happens at registration time, for example when a user installs and activates the present system software on their client. There is also a trusted accounting server, which keeps track of the credits/debits accrued by each user. The central authority that issues keys could be co-located with the accounting server.

When an initiator finds a collaborator's bid to be acceptable, it initiates the process of having the collaborator download content for it. As explained below, requests are issued to each collaborator in chunks. Together with the request for a chunk, the initiator includes a signed note of credit, termed an IOU, indicating the amount of payment being made for that chunk. The collaborator accumulates these IOUs during the collaboration session.

At a later time, perhaps when it has better connectivity (say on a high-speed WLAN), it transmits these to the accounting server for redemption. The accounting server credits the collaborator's account for the corresponding amounts, provided the IOUs have not already been redeemed. The IOUs include an expiration time, which helps limit the amount of history the accounting server needs to maintain to detect duplicate redemptions, while still giving the payee (i.e., the collaborator) sufficient latitude in communicating with the accounting server only when convenient.

Although the IOUs are signed by the initiator, the collaborator needs the assurance that these are original, not duplicates that have already been used as payment. So at the start of a collaboration session, the collaborator conveys a nonce of its choosing to the initiator and asks that this be included (and signed) in all IOUs issued to it during the session.

An IOU may not identify the payee, i.e., the collaborator, for privacy reasons, as discussed in below. So to prevent an eavesdropper from stealing and redeeming the IOU (thereby denying the rightful payee the opportunity to redeem it), the IOU is encrypted, for example using a pairwise key negotiated between the initiator and the collaborator.

Thus, an IOU may be of the form:

IOU={key_{pub}, amount, nonce, seq, exp, signₖₚᵣᵢᵥ},

including the payer's public key (key_{pub}), the amount of credit (amount), the nonce supplied by the payee (nonce), a sequence number that is incremented for each additional IOU issued with the same nonce (seq), the expiration date of the nonce (exp), and the signature generated with the payer's private key (signₖₚᵣᵢᵥ).

The IOU is a credit note that remains valid beyond the ephemeral association between an initiator and a collaborator. Its construction, and the assumed existence of a PKI, give the payee the assurance that it is valid, without having to communicate with the accounting server online. (The converse problem of protecting the initiator from a collaborator who fails to perform the service for which it has been paid is discussed below.) Also, IOUs are in no way limited to monetary credits; the same mechanism could be used to exchange and accrue arbitrary forms of credits (e.g., energy credits). Note that the mention of a credit card herein is only as a form of identity and does not necessarily imply monetary payments.

A payee may accumulate a large number of IOUs from a payer during a long collaboration session. To avoid having to redeem these individually, the payee can, at any point in the collaboration session, request the payer to issue a new, aggregate IOU to replace a large number previously issued IOUs. The new IOU is made conditional on none of these prior IOUs having been redeemed. Rather than list each individual prior IOU, the new IOU just includes the nonce and sequence number range of the IOUs that it is conditioned on.

In embodiments, the payer may not remain anonymous since it needs to sign the IOUs and present the public key certificate issued by the central authority. In order to make tracking by payees more difficult, each user may be issued multiple, but a fixed number, of public/private key pairs and certificates. The user can then pick at random which key pair to use when signing IOUs at various times, thereby hiding its tracks to an extent.

To prevent the accounting service from spying on user associations, a technique may be used which was inspired by random forwarding chains used in anonymous communication systems. In the following example, a payer A issues an IOU, IOU_{A}, to a payee B. Rather than redeem the IOU by itself, B forwards it on to a randomly chosen peer, C, who then redeems it at some point in the future. In return for the IOU_{A} forwarded to it, C returns to B a new IOU, IOU_{C} signed by C for the same amount as IOU_{A}. So effectively the transaction is neutral for both B and C.

As a result, the accounting server will not be in a position to establish any association between A and B. While it might deduce an association between B and C (or A and C), there is in fact no privacy-sensitive association between B and C. Indeed, C is just happens to be a user of the present system whom B picked at random and communicated with over the wide-area network at some later point in time. This is in contrast to the privacy-sensitive association between the original payer (A) and the original payee (B), who were likely in the same location and engaged in a collaborative download session.

Protocol Design

The mechanics of forming a collaboration group and performing a collaborative download are now described. The mechanics include three components: a protocol for mobile devices to form groups, a scheme to distribute work amongst the group, and a mechanism for low-level data transport and connection management to fetch data from servers, which are oblivious to the collaboration.

Group Formation

Group formation is the process by which the initiator identifies a set of collaborators. This is a first step in doing collaborative downloads. While the local connectivity offered by the WLAN would, in principle, make it a suitable means for a mobile device to rendezvous with other devices in its vicinity, energy considerations complicate matters. FIG. 1 shows a graph 50 of the power depleted over time by an i-mate PocketPC with Bluetooth and 802.11 networks in varying power states. Standby refers to the condition where both networks are completely shutdown but the device is otherwise powered on. Wi-Fi Always On refers to the condition when the 802.11 alone is powered on. Bluetooth refers to the condition when the Bluetooth network alone is powered on. Waiting Mode refers to the condition when the 802.11 network interface alone is powered up once every 500 milliseconds and stays on for 50 milliseconds.

As can be seen from FIG. 1, there is a high rate of energy depletion on a typical mobile phone with its 802.11 interface always turned on. This high energy depletion motivates mobile devices to switch off their 802.11 cards or put them in a power saving mode to conserve battery, particularly in environments where there are no Wi-Fi access points. Since this is the environment of interest, the protocol should not depend on WLAN cards being switched on in anticipation of group formation requests, which complicates the rendezvous process. Indeed, groups in the present system are created opportunistically by the initiator, without advance notice to potential collaborators. Furthermore, group formation should work correctly when mobile devices move in and out of range. It should tolerate non-responsive initiators and collaborators, as well as multiple simultaneous initiators.

To enable devices to rendezvous yet conserve energy, devices using the present system, by default, keep their WLAN cards in a low-energy mode called the waiting mode. In this mode, devices periodically wake up their WLAN cards and broadcast an “I-am-Alive” message and await a response for a certain period of time before shutting of their WLAN card.

The initiator keeps its WLAN card always switched on and listening for I-am-Alive messages. It collects I-am-Alive packets for a total time of T_{G} (set to 1 second in the experiments explained below), to form a group as described below. The waiting mode is inspired by the standard Power Saving Mode (PSM) in IEEE 802.11 NICs. However, unlike PSM, the waiting mode does not depend on any interaction with wireless access points. It also offers the flexibility of less frequent wakeups than standard PSM, thereby helping conserve energy.

Each collaborator computes the cost of using its resources and sends a bid in the I-am-Alive message to the initiator. The bid contains the price of using the collaborator and an estimate of the WWAN download speed it is able to offer. The initiator first determines the set of collaborators that has an acceptable cost and then distributes work to this group in a way that optimizes the data transfer.

The detailed group formation protocol for 802.11 may be as follows:
1) Each node i periodically wakes up its WLAN card and broadcasts an I-am-Alive message with the following information and waits for time T_{A}.
   a) TCᵢ: The cost to the initiator for downloading one unit of data using this node. How each node calculates this cost is described above.
   b) Bᵢ: The WWAN speed that the node expects to be able to offer to the initiator. This may only be an estimate of the WWAN speed and could be inaccurate. The method for dealing with these inaccuracies is described below.
2) On receiving an I-am-Alive message, the initiator responds with a CCHECK message containing the following information.
   a) The URL of the file it needs to download.
   b) The time (T_{G}-T_{C}) after which it will reply to the node with a collaboration acknowledgement. T_{C} is the amount of time currently elapsed since the start of the group formation process. Depending on the length of T_{G}-T_{C}, the node can decide to conserve energy by turning of its WLAN NIC until just before the appointed time.
3) On receiving a CCHECK message, the device checks its local cache for the URL mentioned in the message. If it has it in its cache and is up-to-date (as determined by an “if-modified-since” HTTP request), it unicasts a reply to the initiator informing it of the availability of the file. Otherwise, the node takes no action, but keeps its WLAN card on for the specified time period awaiting a message from the initiator.
4) After time T_{G}, the initiator evaluates all the I-am-Alive messages and selects the list of collaborators using the method described below.
5) The initiator sends out a CACK message to all the selected collaborators informing them of the fact that they have been enlisted in the collaboration group.

If the initiator does not receive any I-am-Alive message within time T_{G}, it resets its timer and starts over. This happens a specified number of times after which the initiator aborts its group formation attempt. If the nodes do not receive any CACK message within the time specified in the CCHECK message, they switch back to waiting mode. At the end of the group formation mechanism, the initiator has the list of all the nodes that are selected for collaboration.

A collaborator may receive CCHECK and subsequent CACK messages from distinct initiators. The protocol does not prohibit collaborators from responding to these messages, but in the current implementation, collaborators respond only to the first initiator.

While focus has been on using an 802.11 WLAN for group formation, mobile devices that have an 802.11 interface often also have a Bluetooth interface. Although Bluetooth is unlikely to be suitable for high bandwidth data transfer, it has one virtue that favors its use for group formation. The energy drain of Bluetooth is much lower than that of 802.11 as is evident from FIG. 1. Thus, unlike 802.11, it may be reasonable for the Bluetooth interface to be turned on all the time, even if no groups are formed for extended periods. However, the group formation algorithm would need to be adapted given the smaller range of Bluetooth compared to 802.11 and the point-to-point rather than broadcast nature of Bluetooth connectivity.

Regarding group selection criteria, the initiator must choose a set of collaborators in Step 5 above. It does this based on one of two algorithms described below. In the following discussion, it is assumed that the user wants to download a file of size F and he/she is willing to incur a cost of C to do so. Also recall that each I-am-Alive serves as a bid from a potential collaborator and contains a value for TC and B, i.e., the cost to the initiator and the bandwidth it will get by using that collaborator.

#1: Threshold-based group selection: A first algorithm is based on a simple thresholding scheme. Given F and C, the initiator calculates the value T̅C̅=C/F, the maximum per byte cost threshold. All nodes whose bids contain a TC value less than T̅C̅ are selected and sorted in the descending order of their WWAN speeds (also contained in their bids), and the first n nodes are selected as collaborators (with n chosen suitably to limit the size of the collaboration group). This conservative choice of collaborators guarantees that the overall cost will not exceed C regardless of how the workload is distributed across the collaborators.

#2: Opportunistic group selection: A second scheme is less conservative. Rather than be restricted only to nodes whose per byte cost is under the C/F threshold, it is possible to recruit some collaborators that are more expensive. Nevertheless, through a suitable workload distribution, it is ensured that the overall cost still does not exceed C. As shown below, this less conservative approach could yield significant performance gains.

This scheme is based on formulating group selection as an optimization problem. The goal of the optimization is to minimize the total time taken to download F bytes of data subject to the cost constraint C. If each collaborator i, working in parallel, downloads xi bytes with bandwidth Bi, the total time taken to download the file is the maximum of {xᵢ/B₁, x₂/B₂, . . . , x_{N}/B_{N}}, where N is the number of distinct I-am-Alive packets received by the initiator. The optimum values of xᵢ, i=I . . . N may be determined so as to minimize the total time subject to the constraints:

$$\begin{matrix}{\sum }_{i - 1}^{N} {TC}_{i} {x}_{i} \leq C & ( 1 ) \\ {\sum }_{i = 1}^{N} {x}_{i} = F & ( 2 ) \\ {x}_{i} \geq 0 , i = 1 … N & ( 3 )\end{matrix}$$

The nodes with non-zero xi values are selected for the collaboration group. The remaining drop out of the protocol.

Two work distribution strategies may be implemented: a work-queue algorithm and an opportunistic algorithm. As explained below, these two algorithms are intended to be used in conjunction with threshold-based group selection and opportunistic group selection, respectively.

#1: Work-Queue Algorithm: In this algorithm, the initiator gets the total size of the file to be downloaded and forms a work-queue with fixed equal-sized byte ranges of the file. The total file size is obtained by querying the server, for example with an HTTP HEAD request. Collaborators query the initiator and pick up the next available item from the work-queue, download the amount of data as specified in its work-item and return it to the initiator. Each collaborator picks up more work when it is done with its current work item, and keeps working until the queue is empty.

Thus the work performed by each collaborator is proportional to its WWAN speed, without the initiator having to allocate work explicitly. Also, since the initiator does not allocate work, the work-queue algorithm is only suited for use with the conservative threshold-based group selection. Otherwise, it is not guaranteed that the overall cost constraint will be satisfied.

The amount of data in a work-item, called the chunk size, needs to be picked appropriately. Too large a chunk size would result in the algorithm being less agile to changing speeds and also result in a high amount of salvaging in case of any of the collaborators going down. On the other hand, too low a chunk size will place considerable overheads for every WWAN download and adversely affect the throughput. Experiments set forth below indicate that a chunk size of 200 KB is appropriate for HTTP downloads.

#2: Opportunistic algorithm: The opportunistic work distribution algorithm follows directly from the opportunistic group selection algorithm discussed above. It uses the same optimization framework with one key difference—rather than solve the optimization problem and compute the work allocation (viz. the xᵢ values) just once for the entire file, it is solved repeatedly over smaller partitions of the file. The initiator divides the file of size F into fixed-size partitions of size p bytes each and apportions to each partition a cost budget of (C/F)p.

Furthermore, rather than persist with the bandwidth estimates, Bᵢ, provided by the collaborators initially, an exponentially weighted moving average may be computed of the actual bandwidth observed for each collaborator during the course of the download. These observed bandwidth values (OBᵢ) are used when solving the optimization problem for later partitions.

Unlike the work-queue algorithm, the initiator explicitly allocates work to the collaborators to ensure that the cost constraint is satisfied despite the presence of expensive collaborators. Computing work allocation on partitions rather than the entire file makes the work distribution more adaptive to dynamic fluctuations in bandwidth.

The present system adapts well to changing conditions, both to provide good performance and to avoid stomping on non-the present system traffic. As noted above, the present system may only seek to utilize unused bandwidth at the collaborator nodes. Therefore, it needs to detect when a previously idle WWAN link has become busy, and then back off. A simple busyness detector may be implemented that compares the volume of bytes sent/received on the WWAN interface with the volume of traffic sent/received by the present system. If the difference is large, it implies that there is a significant amount of non-the present system traffic. Therefore, the present system stops using that WWAN link (beyond the current chunk, if any, in progress) until the link falls idle again.

A collaborator node could unexpectedly slow down or fail, either because of the above backoff procedure or because of other network dynamics (e.g., it may move out of the range of the initiator). The present system's work distribution procedure needs to be agile enough to adapt to these.

The work-queue algorithm accommodates such fluctuations and failures by design. The slowdown or failure of a collaborator would mean that the affected node would automatically slow down or stop the process of picking up additional work items. In this way, other collaborators may automatically pick up a larger share of the workload.

In the opportunistic work distribution algorithm, the initiator estimates how long it should take for a collaborator to complete the work allocated to it. If a much longer time has elapsed but the collaborator still has not finished its work, the initiator asks it for its status (i.e., what fraction of the download has completed). The initiator then allocates the remaining work on the pending chunk to another collaborator, assuming there is one that is expected to complete the remaining download faster.

With regard to data transfer and connection management, apart from forming a collaborative community and distributing work to its members, a way needs to be arranged for each collaborator to fetch its share of data from the site providing content. The data transfer protocol may be implemented at the HTTP level; specifically, the byte-range request defined in HTTP/1.1 may be exploited. This is supported by most web server implementations. Using HTTP has the benefit that it does not require specialized proxies in the infrastructure to split and splice flows (e.g., the inverse multiplexers described in prior work). This eases deployment.

However, an issue that arises with HTTP-level striping is that the server providing the content may require session establishment and the exchange of session-level information before it will serve up content. Maintaining session semantics can be problematic. Collaborators must now either share a single session with the initiator, or collaborators have to initiate multiple sessions simultaneously. This may run into problems because, for instance, the server may disallow session information (e.g., an HTTP cookie) to be used from multiple (collaborator) IP addresses concurrently. This difficulty can be dealt with by having the requests through all collaborator routed through a common web proxy in the infrastructure, which would then present a single IP address to the server. Note that web proxies are “standard” infrastructure and in not the present system-specific, unlike the specialized network-layer proxies required in prior work.

Another issue is that the initiator may have to share session-level secrets (e.g., HTTP cookies) with the collaborators, which it may be unwilling to do. However, this problem can be alleviated by limiting cookie lifetime.

Experimental Evaluation

The present system may be implemented on a computing system environment as described hereinafter. In this example, the system is implemented on a laptop equipped with an Intel Pentium 4 processor with a GB of RAM running Windows XP SP2. The laptops are equipped with both IEEE 802.11 cards and CDMA-based 3G data connections. The laptops use the Sierra Atlantic PCMCIA wireless cards as their WWAN link. The average speed attained with these cards was 95 kbps. All the laptops are equipped with D-Link DWL-AG132 USB 2.0 dongles. This is an 802.11a/b/g radio based on the Atheros chipset. The device driver for this NIC was modified to be able to send custom payloads in the control messages needed for collaboration group formation.

While the use of a laptop may not significantly affect the network throughput numbers, laptops may not be representative of less powerful devices for compute-intensive tasks (e.g., digital signature operations) as well as energy consumption results. So for the latter, microbenchmarks are reported measured on an i-mate Pocket PC (PPC) device (195 MHz OMAP850 processor with 64 MB RAM).

1) Group Formation: The nodes use the Probe Request in IEEE 802.11 as the I-am-Alive message. The BSSID and SSID fields in this message are overloaded to specify the TC and the WWAN speed of the node. The initiator continuously listens for probe requests and on receipt of one, unicasts a Probe Response packet informing the node of the URL to download and the time for which it has to stay awake. After the group selection, a Probe Response is used as a CACK to notify the selected collaborators.

Nodes that receive the CACK message, join the IEEE 802.11 ad hoc network advertised by the initiator. The CACK contains the SSID of this ad hoc network. The process of the collaborators scanning and finding the network with this BSSID and subsequently joining it consumes a significant amount of time. Hence, the initial transmission of the bids and the group selection may be done via the lightweight probe requests and probe responses and do the ad hoc network formation only after the collaborators are selected.

In an implementation, nodes wake up once in every 500 milliseconds (T_{G}), transmit an I-am-Alive message and wait for 50 milliseconds (T_{A}). Note that this is one fifth of the frequency generally used in Power-Saving-Mode (PSM) in IEEE 802.11. The initiator waits for twice this frequency, i.e., 1 second, to collect all the I-am-Alive messages. The time taken for setting up the entire group formation process was measured including the formation of the ad hoc network, for varying number of nodes in the network. The experiments indicate that the time taken for the ad hoc network formation is independent of the number of nodes in the network and averages under 5 seconds. Hence the total time taken for the group formation, including the time the initiator listens to the I-am-Alive messages is under 6 seconds.

2) Optimal Chunk Size: In the work-queue algorithm, the collaborators download chunks of data as specified in the work-items. Since there is a significant overhead associated with initiating and closing an HTTP connection, it is important to arrive at an optimal value of the chunk size. While very high chunk sizes affect the agility and failure-handling capability of the algorithm, very low chunk sizes places a significant overhead and hence adversely affects the throughput.

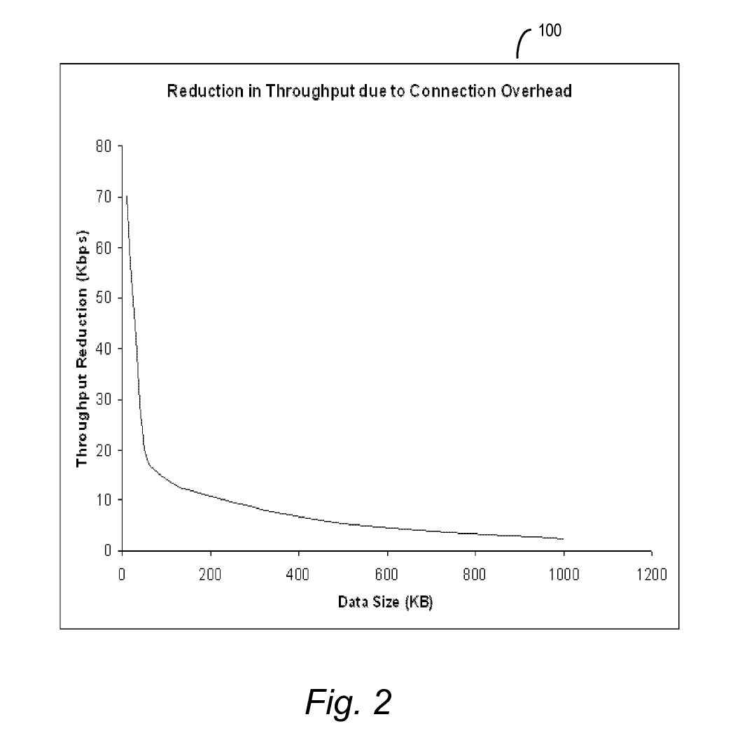

The HTTP throughput was evaluated for varying data sizes by measuring two parameters, the time taken for the download excluding the initial connection establishment phase and the total time taken. While the former gives an estimate of just the data transfer rate, the latter corresponds to the effective throughput. It was observed that the difference in these two values tended to zero as the amount of data downloaded increases. FIG. 2 is a graph 100 plotting the reduction in throughput due to the initial connection establishment for HTTP downloads. Notably, the slope of the graph sharply decreases as the download size just exceeds 100 KB and the loss in throughput is very small (less than 10 kbps) if the download size is over 200 KB. Hence it is assumed that 200 KB is a reasonably optimal chunk size for any collaborator to download via HTTP.

3) HTTP Throughput and Speed up: The throughput and speed-up of the present system was measured by downloading an 8 MB file via HTTP from a data source on the Internet. The work-queue algorithm was used to distribute the workload among the collaborators and the HTTP byte-range request format to request for parts of a file from the server. To provide a baseline for measured HTTP throughput the experiment was performed with no collaboration.

TABLE 1
Variation of the Throughput of the present system with varying
collaboration group size (including the initiator)

| Number of members | Throughput (kbps) |
|---|---|
| 1 | 95 |
| 2 | 170.25 |
| 3 | 256.57 |
| 4 | 333.55 |
| 5 | 438.77 |

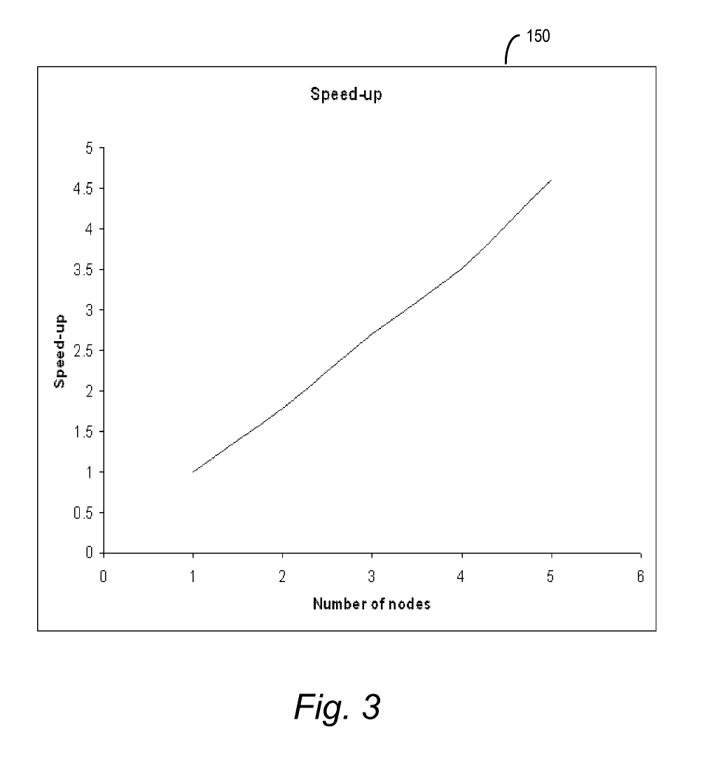

As expected, the speed-up values increased proportionately with the number of nodes. The average HTTP throughput achieved with a single laptop (the initiator) was 95 Kbps. FIG. 3 is a graph 150 of the speed-up and Table 1 shows the throughput values as the size of the community is increased.

4) Comparison of Work-Queue and Optimized Work Distribution Algorithms: The main advantage of the opportunistic algorithm over the simple work-queue model is its ability to utilize even those nodes in its WLAN whose costs are not strictly lower than the initiator's admissible cost. Among a given set of nodes, the opportunistic scheme could potentially enlist more collaborators and thereby achieve higher throughput.

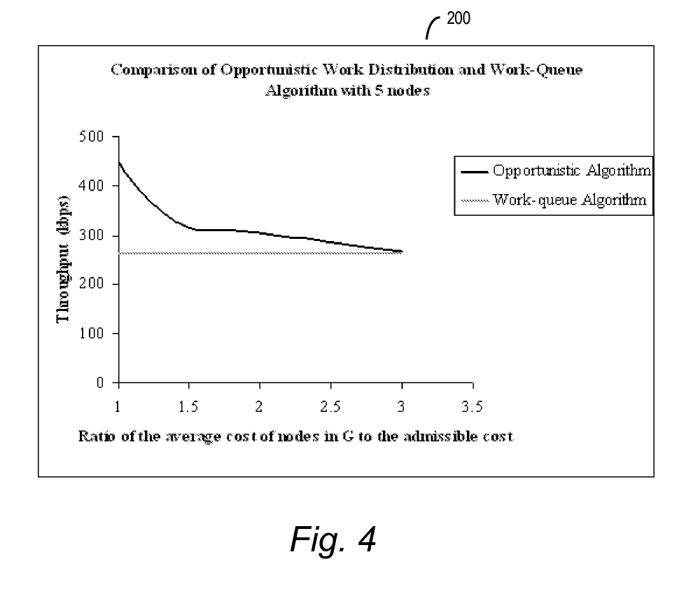

To validate this, the opportunistic work-distribution algorithm was implemented with community sizes of 5 and 3. Let G be the set of the nodes with T̅C̅ values greater than the admissible value. The size of G was fixed to be 2 and 1 respectively for the two communities. Let T̅C̅_{G} be the average value of TC of the members in G. The ratio of T̅C̅_{G}/ T̅C̅ is varied and the present system's throughput measured. FIG. 4 is a graph 200 plotting the throughput of the present system as the ratio T̅C̅_{G}/ T̅C̅ increases in a five-node scenario.

The work-queue algorithm is not affected by the variation in G because it never considers nodes in this set for distributing work. The horizontal line in FIG. 4 is indicative of this. On the other hand, the opportunistic work-distribution algorithm is capable of using nodes in the set G as long as their costs are not significantly above the admissible cost, T̅C̅. The results show that up to a factor of 2, the opportunistic work distribution is appreciably superior to the work-queue algorithm. For higher ratios, the opportunistic algorithm starts allocating lesser work to the members in the set G and utilizes them minimally to meet the cost constraint. In the limit the algorithm behaves as though the nodes in G did not exist.

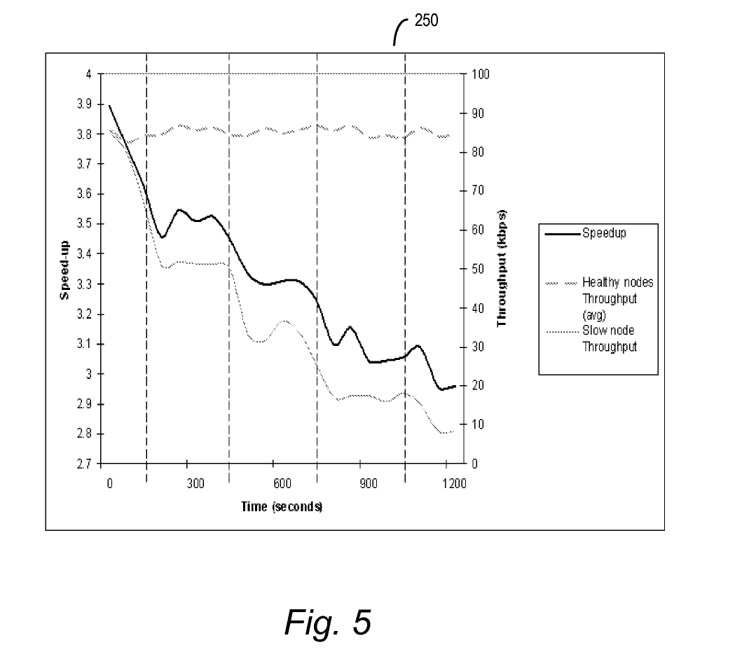

The agility, adaptation and behavior of the present system is now explained when in the presence of variability in collaborator's network characteristics. Specifically, when a collaborator's WWAN link quality is degraded it should be shown that the present system can automatically reapportion the work among collaborators. The case of an initiator using the work queue model to distribute work to four collaborators is considered. The download rate of a single collaborator is artificially slowed and the adaptability of the system is observed. FIG. 5 is a graph 250 showing the effect of progressively slowing a single collaborators from 0.75 to 0.1 of its original rate. The vertical dotted lines indicate the slow down events. It is observed that even as the throughput of the slow node progressively decreases, the average throughput of the healthy nodes is invariant and they automatically start servicing more chunks from the work-queue.

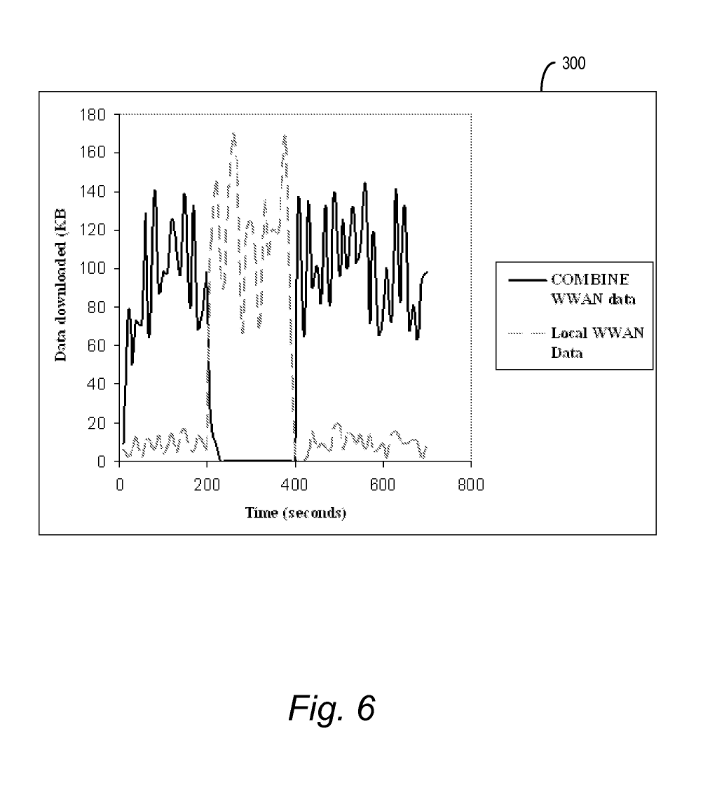

Prioritization of local work: the present system aims to leverage the unutilized WWAN bandwidths of the collaborators to achieve throughput enhancement and hence it is crucial that there is a mechanism in place that automatically prioritizes local WWAN activity over the present system activity. A prioritization scheme has been implemented where the collaborators periodically check the ratio of the present system WWAN activity and the total local WWAN activity and shut of the present system activity when this ratio falls below a threshold, indicating an increase in local WWAN activity. This was simulated by intentionally downloading a file locally at a collaborator during the course of the present system's activity. FIG. 6 is a graph 300 illustrating the efficacy of the prioritization module. As soon as a surge in the local WWAN activity is seen, there is a drop in the amount of data downloaded by the collaborator as a part of the present system.

The initiator generates IOUs to the collaborator using cryptographic signing techniques for security. The impact of cryptographic operations on the throughput and battery energy will now be described. The impact of signing an IOU on the i-mate PPC by way of a microbenchmark is evaluated.

It is assumed that an IOU is about 256 bytes long. To sign an IOU, the initiator (i.e., the mobile phone) calculates a hash of the IOU, and then signs the hash with its private key. Verification involves calculating the hash of this message and decrypting it with the public key.

Previous work indicate that Elliptic Curve Digital Security Algorithm (ECDSA) has a better performance, especially on mobile devices, compared to traditional cryptosystems like RSA because of the reduced key sizes. The security of ECDSA with a key length of 160 bits is equivalent to a 1024-bit RSA encryption.

The time taken and power expended was measured for the signing and verification operations of the digital signatures on the i-mate Pocket PC by averaging over 1000 iterations. SHA₁ was used for hashing and ECC for the encryption and decryption operations. Table II show the results.

TABLE II
Power Consumption of an i-mate Pocket PC for
cryptographic operations with ECDSA

| | Energy (mJ) | Time (ms) |
|---|---|---|
| Verifying | 1.43 | 6.79 |
| Signing | 166.5 | 280 |

The energy overhead due to the IOU's may be shown to be negligible on the device. The experiments indicate that the maximum transfer possible on the WWAN in a single lifetime of a battery is approximately 150 MB. Assuming that an IOU is generated every 200 KB (optimal chunk size), a device generates a total of 750 IOU's. It can be easily verified that the total cost for the generation of these 750 IOU's is a very small fraction (0.75%) of the total battery capacity (3.7 V, 1250 mA-h). Hence it is conclude that the IOU scheme does not place a significant overhead on the device.

The effectiveness of the simple model presented above is evaluated in estimating battery depletion. The focus here is on the case where the i-mate PPC only has a WWAN NIC. Recall that the battery depletion model is:

BD=time_elapsed*BDₜ+bytes_sent_or_recd*BD_{d}.

BDₜ and BD_{d} may be estimated using controlled “calibration” experiments. To estimate BDₜ, i.e., the battery depletion per unit time, the device and its WWAN NIC (but do not perform any network transfers) is powered on and it is measured how long it takes for battery to fully discharge (i.e., go from 100% to 0% battery remaining). BDₜ is then estimated as 1/discharge-time.

Then, to estimate BD_{d}, i.e., the battery depletion per unit data, a similar calibration experiment is performed with one crucial difference: the WWAN NIC is engaged in a continuous download at full throttle. how long it takes for the battery to fully discharge is recorded, as well as the amount of data received during this period. Using BDₜ and the discharge time, how much of the discharge was due to the device and the WWAN being simply turned on is computed over this period. The remaining discharge is attributed to actual data reception; dividing it by the amount of data received yields an estimate of BD_{d}.

Next, how accurately BDₜ and BD_{d} can be estimated is examined based on observations made while the device is engaged in “system-like” network activity rather than the steady and controlled workload of the calibration experiment. The system-like workload comprises large bursts of data transfer (1-5 MB in size at random), interspersed with idle periods ranging up to 10 minutes in duration. The battery remaining at the beginning and end of each burst is recorded. The results from two runs of this experiment conducted a day apart are reported. The two runs included 27 and 32 bursts of data transfer activity, respectively.

TABLE III
Estimates of battery depletion per second and per KB.

| | BDₜ | BD_{d} |
|---|---|---|
| Experiment | (per second) | (per KB) |
| Calibration | 1.1E−5 | 5.1E−6 |
| Run #1 | 2.43−5 | 4.43−6 |
| Run #2 | 2.4E−5 | 4.2E−6 |

As reported in Table III, the estimates of BDₜ and BD_{d} obtained from the system-like runs match those obtained from the calibration experiment reasonably well. More importantly, the estimates obtained from one run match those from the other very well. It was verified that the estimates of BDₜ and BD_{d} from run #1 yield accurate estimates of battery depletion during various subsets of run 42 (i.e., sequence of bursts together with the intervening idle periods).

These experiments with the WWAN suggest promise in the ability learn the battery depletion characteristics simply by observing the device in operation.

The present invention further provides security protocols. While collaborative downloading offers a significant performance benefit, it also raises several security issues. This is discussed here along with ways of addressing them that could be incorporated into the present system.

First, there is the issue of privacy, with regard to leaking information on a user's activity to collaborators and/or the accounting system. For example, a collaborator might learn which URLs or files have been accessed by the initiator. However, despite the IOUs signed by it, the initiator can still effectively remain anonymous and difficult to track, as discussed above. So the collaborator does not gain much since it cannot tie back the URLs and files to any specific user.

Second, there is the issue of confidentiality. For example, the initiator might be downloading a music file that is only available to subscribers. Existing end-to-end encryption techniques, employed independently of the present system, would help. For example, with the collaborators operating as web proxies, using SSL would shut them out of the content just as it would any other web proxy.

Finally, there is the issue of ensuring the authenticity of the content downloaded through the collaborators. In the present system an initiator issues an IOU for a chunk of data in advance of a collaborator actually downloading, and supplying the data. A collaborator could cheat, for instance, by failing to perform the requested download or by returning bogus content instead of expending WWAN bandwidth to download the real content. Even if the damage caused to the initiator by any one such instance of cheating is small, a malicious collaborator can accumulate a large volume of ill-gotten credits from multiple initiators over time.

Addressing this problem requires a combination of (a) certification of content blocks by the source (just as systems such as BitTorrent would need) so that the initiator can tell whether it has received valid content, and (b) a reputation system to blacklist persistent cheaters. Such blacklisting is facilitated by the availability of an identity infrastructure, which helps identify the cheater (e.g., the initiator can request proof of identity from each collaborator at the start of a collaboration session) and a trusted accounting service, which can record complaints against a cheater. Even if the cheater has multiple identities, as noted above, the accounting service can group together the set of identities associated with any user, since it had issued them in the first place.

The present invention further provides a user interface for its use and operation. The present system may operate autonomously, without requiring user input on an ongoing basis. However, since users may expend valuable resources and/or accrue monetary charges, the users should be given the option of exercising control. Following are some ideas on the design of a simple user interface for the present system.

The UI would comprise elements that inform the user and those that allow the user to exercise control. In the former category are “dials” that show the user (a) how much credit/dues they have accrued, (b) the speedup obtained by using the present system, and (c) the amount of resources expended (or remaining), in particular battery power. The user can view these dials as and when desired, and use the information presented to drive how they control the operation of the present system.

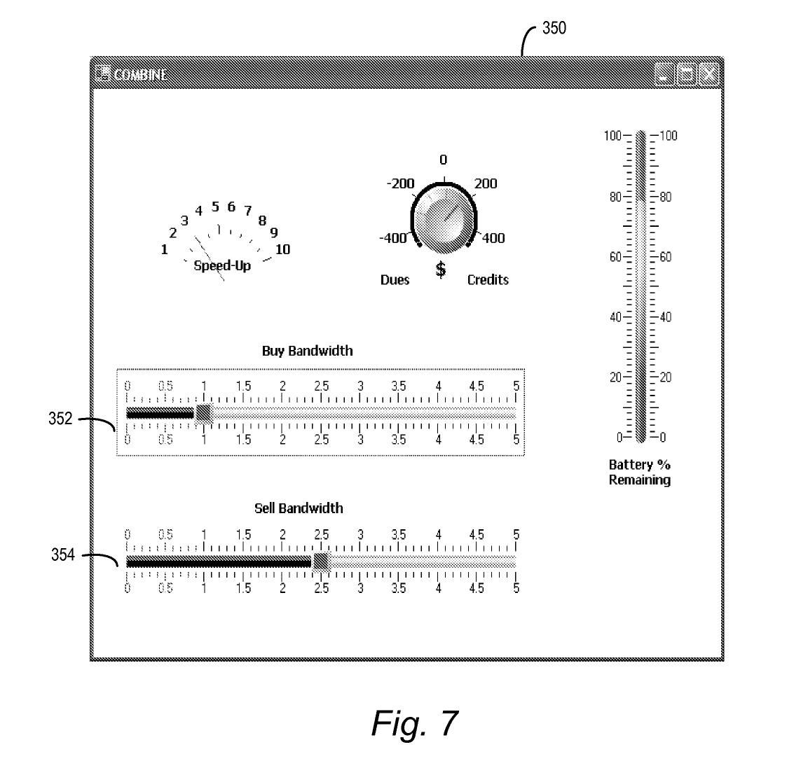

Referring to FIG. 7, to enable user control, the present system may provide a user interface (UI) 350 including two sliders 352 and 354, one each to control the aggressiveness of selling and buying bandwidth, respectively. The slider settings are translated to numerical factors, Kₛ and K_{b}, to control the buying and setting of resources, respectively. These factors are initially set to a neutral value (say 1) to ensure reasonable operation by default. The Kₛ factor is used to scale down or up the price computed in above, to make a collaborator more or less willing to sell its resources. At the extreme, Kₛ is set to infinity, which means that the seller is unwilling to sell for any price. The factor K_{b} operates analogously, with the base price that the buyer (viz., the initiator) is willing to pay pegged to the cost it would incur (in terms of bandwidth and battery) were it to do the download by itself. At the extreme, K_{b} is set to zero, which means that the initiator is unwilling to pay any price, effectively opting out of collaborative downloading.

Overlay demand/bid information from the neighborhood on the sliders could be verified so that the user knows how aggressive they would need to be to make a deal. This could be the basis of a game for (idle) users looking to earn some extra money by parlaying their unused resources.

In embodiments described above, an initiator is the focal point for the process, in that they request, sort through and accept bids from collaborators in accordance with the present system. In an alternative embodiment, for example where the initiator wishes to minimize power expenditure, the initiator may offload the process to a third party, at which point the initiator may turn off their radio. The third party then undertakes the process of request, sorting and acceptance of bids from collaborators, as well as any other tasks otherwise performed by the initiator. In such an embodiment, the initiator may set an appointed time with the third party to wake-up, at which point the initiator may receive the downloaded content from the third party.

Collaborative downloading offers the potential for significant performance gains by utilizing WLAN and WWAN links in combination. The present system offers excellent scaling as well as good adaptability to changing network conditions. The present system also provides a framework to provide practical economic incentives to collaborators. It also makes few demands on the wired and wireless infrastructure than what is already present. These aspects make the present system easy to deploy.

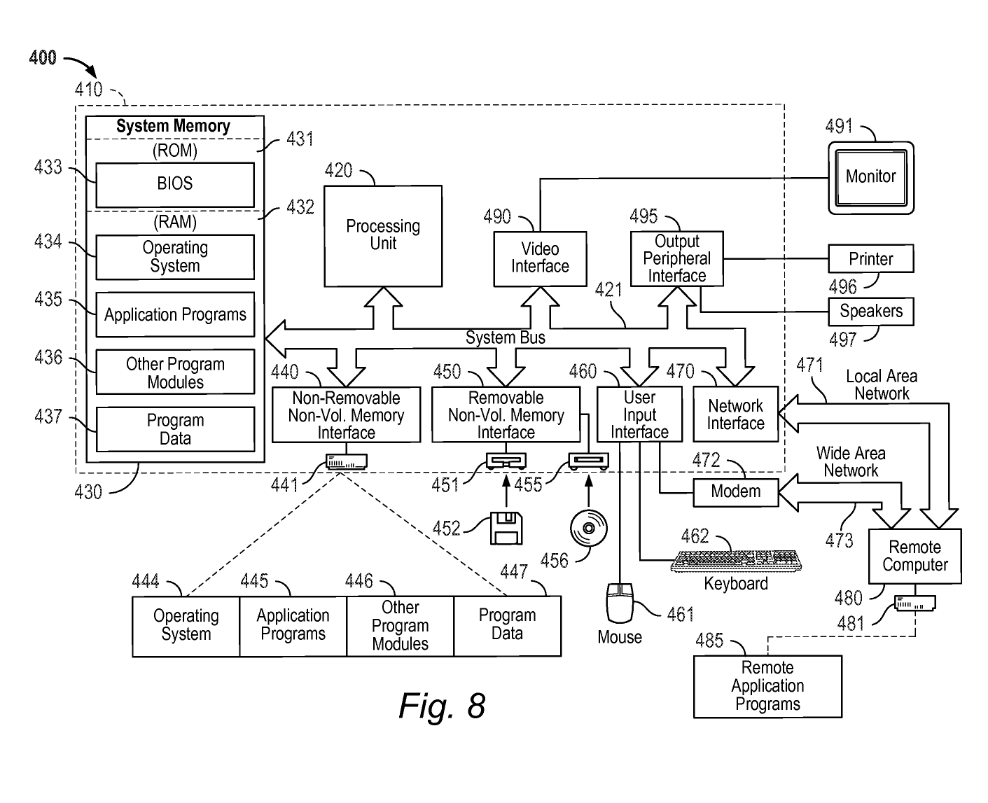

FIG. 8 illustrates an example of a suitable general computing system environment 400 on which the present system may be employed. It is understood that the term “computer” as used herein broadly applies to any digital or computing device or system. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 16, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 16 illustrates operating system 434, application programs 435, other program modules 436, and program data 437.

The computer 410 may also include other removable/non-removable, volatile/nonvolatile computer storage media. By way of example only, FIG. 16 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440. Magnetic disc drive 451 and optical media reading device 455 are typically connected to the system bus 421 by a removable memory interface, such as interface 450.

The drives and their associated computer storage media discussed above and illustrated in FIG. 16, provide storage of computer readable instructions, data structures, program modules and other data for the computer 410. In FIG. 16, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 16. The logical connections depicted in FIG. 16 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 16 illustrates remote application programs 485 as residing on memory device 481. It will be appreciated that the network connections shown are exemplary and other means of establishing a communication link between the computers may be used.

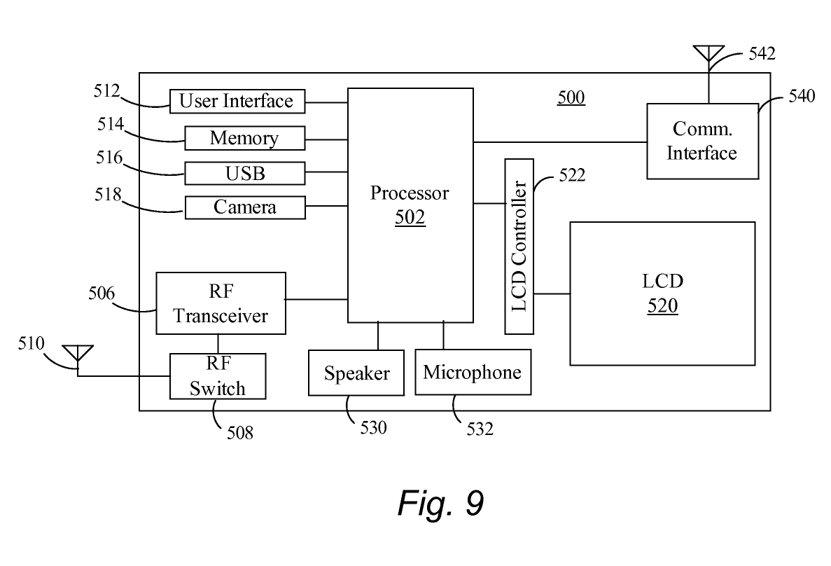

FIG. 9 illustrates an example of a suitable hand-held device 500 on which the present system may be employed. Hand-held device 500 shown in FIG. 9 may be a mobile telephone, PDA or a variety of other known hand-held devices. The device 500 has multiple networks that it can use simultaneously. The components of hand-held device 500 for use with the present invention are known. However, some of the components are shown in the block diagram of FIG. 9 and described hereinafter. Hand-held device 500 may include a processor 502, which may be part of or include a digital baseband and/or an analog baseband for handling digital and analog signals. As is known, processor 502 may include a variety of electronics for handling incoming and outgoing digital voice and data signals.

RF Transceiver 506 and switch 508 are provided for receiving and transmitting analog signals, such as an analog voice signal, via an antenna 510. In embodiments, transceiver 504 performs the quadrature modulation and demodulation, as well as up- and down-conversion from dual-band (800 and 1900 MHz) RF to baseband. The various communication interfaces described herein may include a transceiver and/or switch as in transceiver 506 and switch 508.

Hand-held device 500 may further include a user interface 512 including a variety of actuators in the form of buttons, dials, switches, etc. for controlling hand-held device features and operation. Hand-held device 500 may further include memory 514, for storing hand-held device numbers, address, etc. Memory 514 may additionally store photographic or video images taken with the hand-held device 500. A variety of digital memory formats may be used for this purpose. In one embodiment, memory 514 may be a removable flash memory card, such as those manufactured by SanDisk Corporation of Sunnyvale, Calif. Formats for memory 514 include, but are not limited to: built-in memory, Smart Media cards, Compact Flash cards, Memory Sticks, floppy disks, hard disks, and writeable CDs and DVDs.

Hand-held device 500 may further include a connection 516 for connecting hand-held device 500 to another device. Connection 516 may be a USB connection, but it is understood that other types of connections may be provided, including serial, parallel, SCSI and an IEEE 1394 (“Firewire”) connections.

Hand-held device 500 may further include a camera 518 as is known in the art. An image captured by a lens in the hand-held device is forwarded to processor 502 (or to some dedicated camera processor), which in turn displays that image on an LCD screen 520 in the hand-held device. An LCD controller interface 522 may be provided for receiving the signal from the processor 502 and interpreting it for display on LCD 520. LCD 520 and LCD controller 522 may be of known construction. The LCD controller interface 522 may be part of processor 502 in embodiments.

Hand-held device 500 may include a speaker 530 of known construction for reproducing voice signals, as well as for outputting various ring tones, interactive voice menus and other stored or received audio files. A microphone 532 of known construction may further be provided for receiving voice signals.

Hand-held device 500 may further include a communication interface 540 capable of wireless communication with other devices via an antenna 542. A conventional hand-held device 500 may include a communication interface 540 operating according to various wireless protocols, including Bluetooth, RF and IR.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of collaborative downloading of content to an initiator using the WLAN and the WWAN in combination, the method comprising the steps of:
(a) offering an incentive to a collaborator to bid on the download of content using the collaborator's resources;
(b) participating in the formation of a collaboration group including one or more collaborators having interest in bidding on the download of content using their resources;
(c) receiving one or more bids from collaborators for the download of the content based at least in part on the incentive offered in said step (a);
(d) forwarding to one or more collaborators of an acceptance of a bid; and
(e) receiving a download of the content from one or more collaborators in the collaboration group.

2. A computer implemented method as recited in claim 1, wherein said step (b) of receiving an bids comprises the steps of receiving an estimate of a monetary cost of the service provider charges, and receiving an estimate of a cost associated with the use of the energy of a collaborator's device.

3. A computer implemented method as recited in claim 1, said step (c) of forwarding from the initiator to one or more collaborators of an acceptance of a bid comprises the step of forwarding an acceptance based on a collaborator meeting selection criteria.

4. A computer implemented method as recited in claim 1, said step (c) of forwarding from the initiator to one or more collaborators of an acceptance of a bid comprises the step of forwarding an acceptance based on a comparison of the estimates received in said step (a).

5. A computer implemented method as recited in claim 1, said step (b) of participating in the formation of a collaboration group comprises an energy efficient protocol for the initiator and one or more collaborators to rendezvous with each other and exchange bids.

6. A computer implemented method as recited in claim 5, said energy efficient protocol comprising a low-power radio to achieve energy efficiency.

7. A computer implemented method as recited in claim 5, said energy efficient protocol comprising periodic wakeups to achieve energy efficiency.

8. A computer implemented method as recited in claim 1, further comprising the step of issuing an indication of an amount owed by an initiator to one or more collaborators upon said step (e) of receiving a download of the content from one or more collaborators in the collaboration group.

9. A computer implemented method as recited in claim 8, further comprising the step of receiving a request to redeem the amount owed by the one or more collaborators after said step of issuing an indication of an amount owed by an initiator to one or more collaborators.

10. In a computer system having a graphical user interface including a display and a user interface selection device, a method of controlling a system for collaborative downloading of content to an initiator using the WLAN and the WWAN in combination, the method comprising the steps of:
(a) offering an incentive to a collaborator to bid on the download of content to be sent to the initiator;
(b) receiving one or more bids from collaborators for the download of the content based at least in part on the incentive offered in said step (a);
(c) notifying a collaborator that they have been accepted into a collaboration group including the initiator and one or more collaborators for the download of the content; and
(d) receiving a download of the content from one or more collaborators in the collaboration group.

11. A computer implemented method as recited in claim 10, further comprising the step of displaying to one or more users in the collaboration group how much credit/debt has been accrued, and the amount of resources used and/or remaining on the device of the one or more users.

12. A computer implemented method as recited in claim 10, further comprising the step of allowing a collaborator to provide an indicator of how willing the collaborator is to provide its resources for download as part of the collaboration group.

13. A computer implemented method as recited in claim 10, further comprising the step of allowing an initiator to provide an indicator of how eager the initiator is to receive resources from collaborators for the download of content.

14. A computer implemented method of collaborative downloading of content to an initiator using the WLAN and the WWAN in combination, the method comprising one or more collaborators executing the steps of:
(a) receiving an incentive offer to bid on the download of content to be sent to the initiator;
(b) forwarding a bid to an initiator for the download of the content based at least in part on the incentive offer received in said step (a);
(c) receiving an indication of whether the bid forwarded in said step (b) has been accepted;
(d) participating in a collaboration group of the initiator and one or more collaborators for the download of the content based on the evaluation received in said step (c); and
(e) forwarding the content to the initiator.

15. A computer implemented method as recited in claim 14, wherein said step (a) of receiving an incentive offer to bid on the download of content to be sent to the initiator comprises the step of receiving the incentive offer periodically, upon a WWAN card in a collaborator device awaking from a low power mode.

16. A computer implemented method as recited in claim 15, further comprising the step of awaiting the response of said step (c) prior to returning to low power mode.

17. A computer implemented method as recited in claim 14, wherein said step (b) of forwarding a bid comprises the step of forwarding a bid based on an estimation of the cost of the use of the collaborator device resources.

18. A computer implemented method as recited in claim 14, wherein said step (b) of forwarding a bid comprises the step of forwarding an estimate of the download speed the collaborator device can provide.

19. A computer implemented method as recited in claim 14, wherein said step (d) of downloading the content to the initiator from one or more collaborator devices in the collaboration group comprises the step of the one or more collaborator devices obtaining the content from a third party source and forwarding the content to the initiator.

20. A computer implemented method as recited in claim 14, further comprising the step of redeeming credit accrued based on participating in a collaboration group and downloading content to the initiator.
